(19) United States
(12) Patent Application Publication
(10) Pub. No.: US 2009/0055574 A1
(43) Pub. Date: Feb. 26, 2009

(54) NAND Flash Memory Device And Related Method Thereof

(76) Inventors: Bei-Chuan Chen, Hsinchu (TW); Li-Hsiang Chan, Hsinchu (TW); Chien-Wen Chen, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 11/845,037

(22) Filed: Aug. 25, 2007

(51) Int. Cl. G06F 13/28

(52) U.S. Cl. 711/103

(57) ABSTRACT

The NAND flash memory device contains a NAND flash memory, a mirror data area, and a controller. The mirror data area has a size at least to hold a page of data and is usually formed by random access memory. The controller saves a data to be written into the NAND flash memory that occupies a partial number of the sectors of a first page of the NAND flash memory into the sectors of a second page of the mirror data area. When a new data is to be written into the remaining sectors of the first page of the NAND flash memory, the new data is stored instead into the second page's remaining sectors of the mirror data area. When the second page of the mirror data area is full, the entire second page is written into the first page of the NAND flash memory.

### FIELD OF THE INVENTION

The present invention generally relates to NAND flash memory, and more particularly to NAND flash memory device and a related method for reducing the number of erases performed on the blocks of the NAND flash memory.

### BACKGROUND OF THE INVENTION

Conventionally, a NAND flash memory contains a number of blocks and each block in turn contains a number of pages, each of which is usually a multiple of 512 bytes such as 512 bytes, 1,024 bytes, 2,048 bytes, 4,096 bytes, etc., and is further partitioned into a number of sectors. For example, as shown in FIG. 1, a NAND flash memory contains N blocks (i.e., block1 to blockN) and each block contains N pages (i.e., page1 to pageN). Each page in turn contains 4 sectors. For example page 3 of block 2 contains four sectors: page3_1, page3_2, page3_3, and page3_4. The central processing unit (CPU) accesses memory in consecutive sectors. However, a NAND flash memory is usually read and written in pages.

A NAND flash memory has two important electrical limitations. First, a page of the NAND flash memory cannot be written again as it had been written unless the page's residing block is erased first. FIG. 2A˜2C illustrate how this limitation is overcome by a conventional NAND flash memory. As shown in FIG. 2A, block 1 currently has data stored in page1 to page3 and in sectors page4_1 and page4_2 of page4, and new data is about to be written to sectors page4_3 and page4_4 of page4. As page 4 cannot be written again unless block1 is erased first, the data stored in page1 to page3 and in sectors page4_1 and page4_2 of page4 is first copied into a separate block (i.e., block2), as shown in FIG. 2B. Then, the new data is written into sectors pages4_3 and page4_4 of the block2's page4 as shown in FIG. 2C. The old block1 is then safely erased and thereby recycled for the storage of new data.

A second limitation on the NAND flash memory is that there is an upper limit on how many times a block can be erased (e.g., 100,000 times). The number of erases varies among different NAND flash memory products. However, once a block is erased more times than its upper limit, the block could become a “bad” block and cannot be used again. Therefore, to increase the lifetime of a NAND flash memory, the erase operations to the blocks has to be reduced to as few as possible.

### BRIEF SUMMARY OF THE INVENTION

Therefore, the present invention provides a novel NAND flash memory device and a related method thereof to obviate the foregoing limitations of a conventional NAND flash memory.

The NAND flash memory device contains a NAND flash memory, a mirror data area, and a controller controlling the access to the NAND flash memory and the mirror data area. The mirror data area has a size at least to hold a page of data and is usually formed by random access memory so that it can be accessed without the limitations of the NAND flash memory.

The function of the controller is to save the data to be written into the NAND flash memory that occupies a partial number of the sectors of a first page of the NAND flash memory into the sectors of a second page of the mirror data area. When a new data is to be written into the remaining sectors of the first page of the NAND flash memory, the new data is stored instead into the second page's remaining sectors of the mirror data area. When the second page of the mirror data area is full, the full second page is written in its entirety into the first page of the NAND flash memory. As such, an erase to the block containing the first page is avoided and the NAND flash memory device therefore enjoys an extended lifetime.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing the organization of a conventional NAND flash memory.

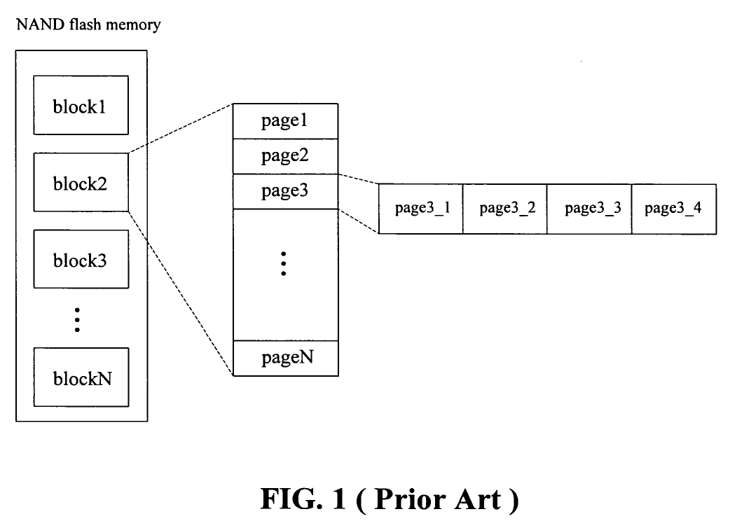

FIG. 2A is a schematic diagram showing a data is to be written into a partially occupied page of a conventional NAND flash memory.

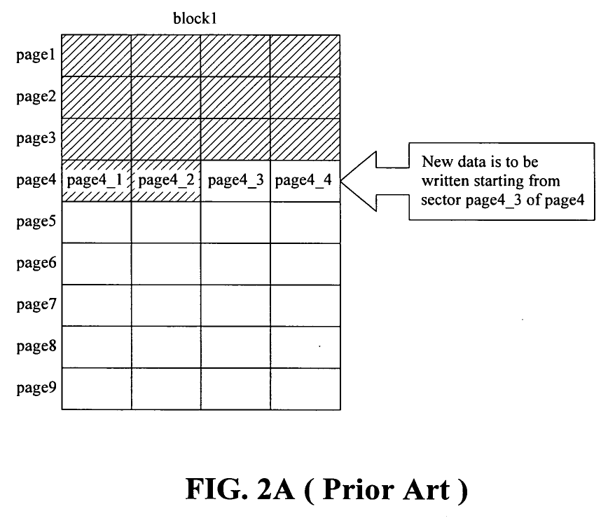

FIG. 2B is a schematic diagram showing the block containing the partially occupied page of FIG. 2A is first copied into a separate block.

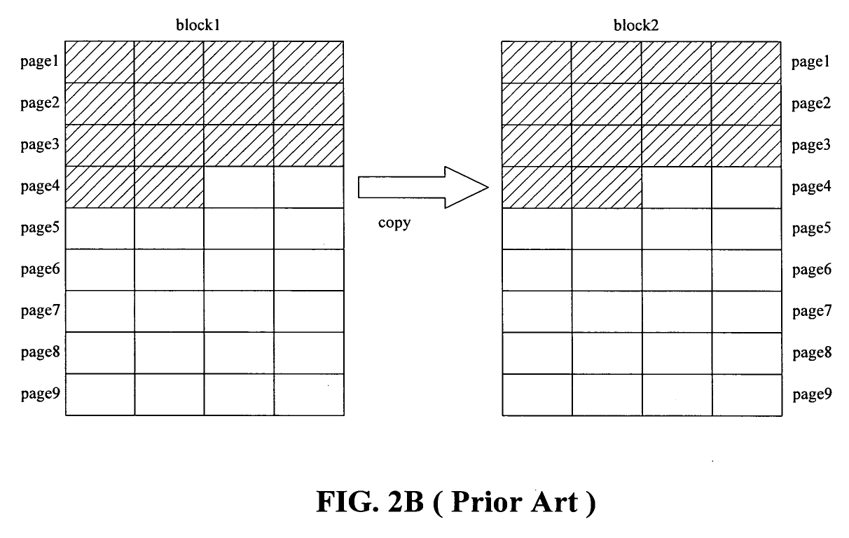

FIG. 2C is a schematic diagram showing the data of FIG. 2A is written into the remaining sectors of the partially occupied page of the separate block.

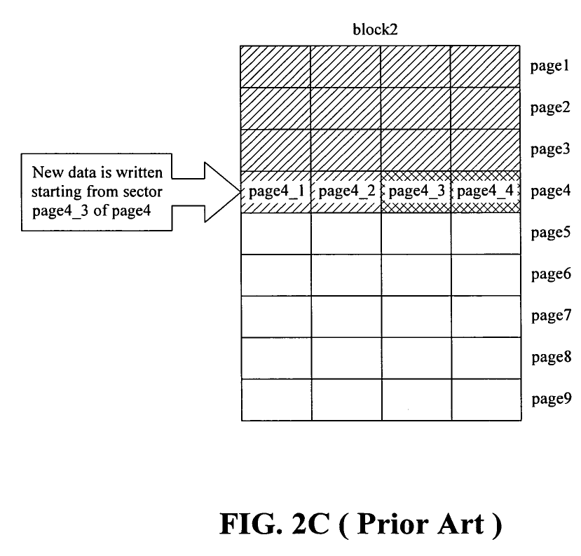

FIG. 3 is a schematic diagram showing a NAND flash memory device according to an embodiment of the present invention.

FIG. 4A is a schematic diagram showing a data is written into the NAND flash memory of FIG. 3 with the last few sectors not constituting a full page being written into the mirror data area.

FIG. 4B is a schematic diagram showing a new data to be written into the NAND flash memory of FIG. 3 immediately following the previous written data of FIG. 4A is written instead into the mirror data area.

FIG. 4C is a schematic diagram showing a full page of data is written from the mirror data area back into the original place in the NAND flash memory.

FIG. 5 is a schematic diagram showing a scenario after FIG. 4A when the new data to be written into the NAND flash memory of FIG. 3 has more data than those required to fill up the mirror data area.

FIG. 6 is a flow chart showing the processing steps of the method of the present invention.

### DETAILED DESCRIPTION OF THE INVENTION

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

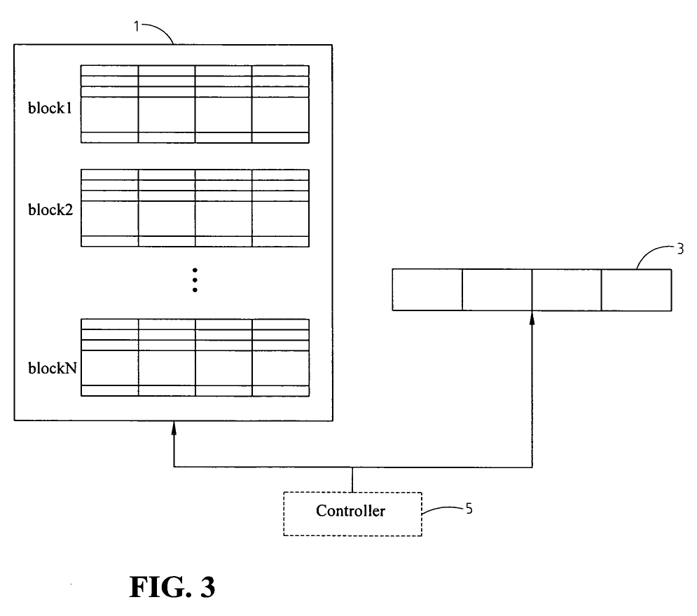

FIG. 3 is a schematic diagram showing a NAND flash memory device according to an embodiment of the present invention. As illustrated, the NAND flash memory device contains a NAND flash memory 1 which contains a number of blocks (i.e., block1 to blockN). Each block contains a number of pages, each of which in turn contains a number of sectors. In FIG. 3, each page is shown to have 4 sectors. The NAND flash memory device also contains a controller 5 and a mirror data area 3. The mirror data area 3 could be an independent memory device or a buffer used by the firmware of the controller 5. The mirror data area 3 is usually implemented as a random access memory (RAM) (therefore, the mirror data area 3 does not suffer the limitations of the NAND flash memory). The size of the mirror data area 3 should be at least to hold a page of data. As illustrated, a page of the mirror data area 3 is partitioned into the same number of sectors as the NAND flash memory 1.

The controller 5 controls data access to the NAND flash memory 1 and the mirror data area 3. Simply put, the function of the controller 5 is to save the data to be written into the NAND flash memory 1 that occupies a partial number of the sectors of a first page of the NAND flash memory 1 into the sectors of a second page of the mirror data area 3. When a new data is subsequently to be written into the remaining sectors of the first page of the NAND flash memory 1, the new data is stored instead into the second page's remaining sectors of mirror data area 3. When the second page of the mirror data area 3 is full, the full second page is written in its entirety into the first page of the NAND flash memory 1.

Please note that the controller 5 is able to handle the data stream and the command stream in parallel. Therefore, the access to the mirror data area 3 and the NAND flash memory 1 can be conducted while the controller 5 is calculating the next optimal location for storing data, thereby achieving a high performance.

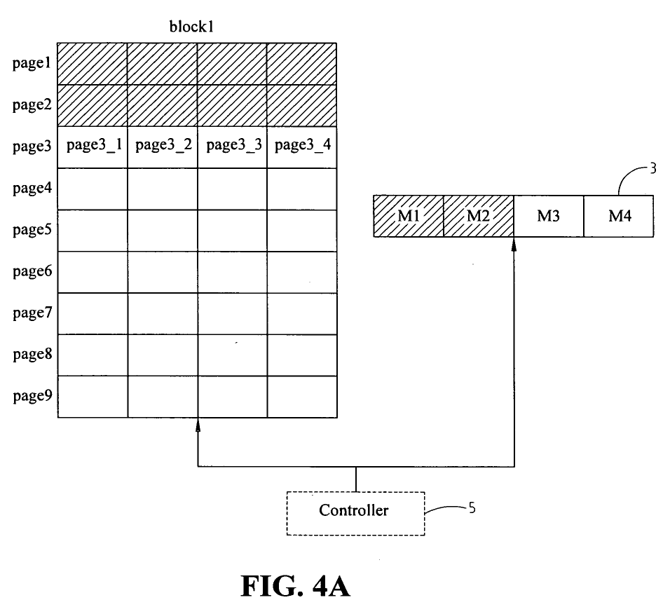

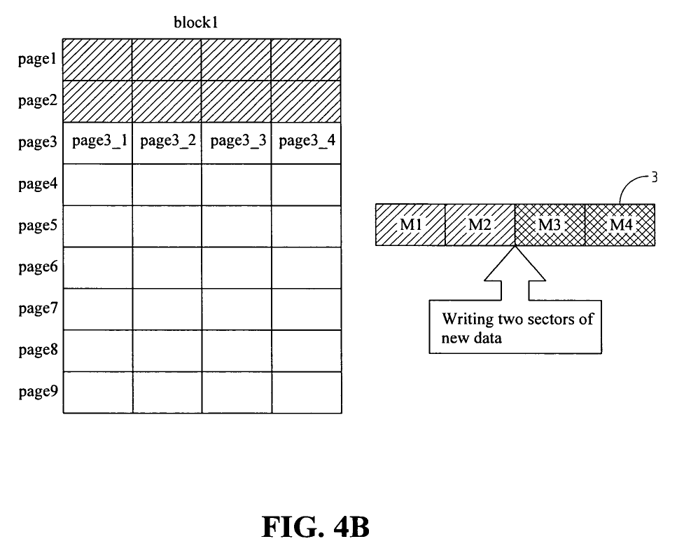

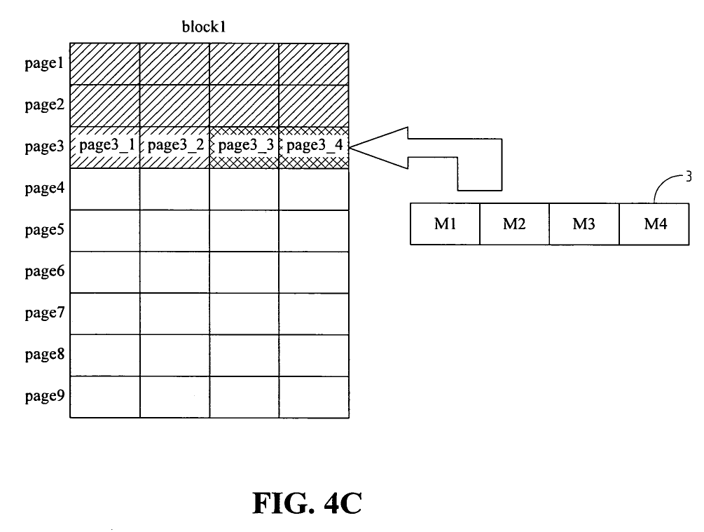

The following is an example. In FIG. 4A, a block1 of the NAND flash memory 1 contains 9 pages (i.e., page1 to page9) and each page contains 4 sectors (e.g., page3_1, page3_2, page3_3, and page 3_4). Each sector has 512 bytes and therefore each page has a size of 2K bytes. The mirror data area 3 also has a size of of a page (i.e., 2K bytes) and is partitioned into 4 sectors (i.e., M1, M2, M3, and M4) as well. When a 5K data whose target address starting from the first address of page1 is to be written into the NAND flash memory 1, the first 4K data occupies the first two pages (i.e., page1 and page2) of the NAND flash memory 1, and the remaining 1K data, as they does not occupy a full page (i.e., page3), is saved instead into the first two sectors (i.e., M1 and M2) of the mirror data area 3.

Then, as shown in FIG. 4B, when a new 1K data is subsequently to written into page3 whose target address starting from the first address of the remaining sectors (i.e., page3_3 and page3_4), the new data instead is stored into the remaining sectors (i.e., M3 and M4) of the page of the mirror data area 3. When a full page of data is stored in the mirror data area 3, the full page of data is then written in its entirety into the original place (i.e., page3) of block1, as shown in FIG. 4C.

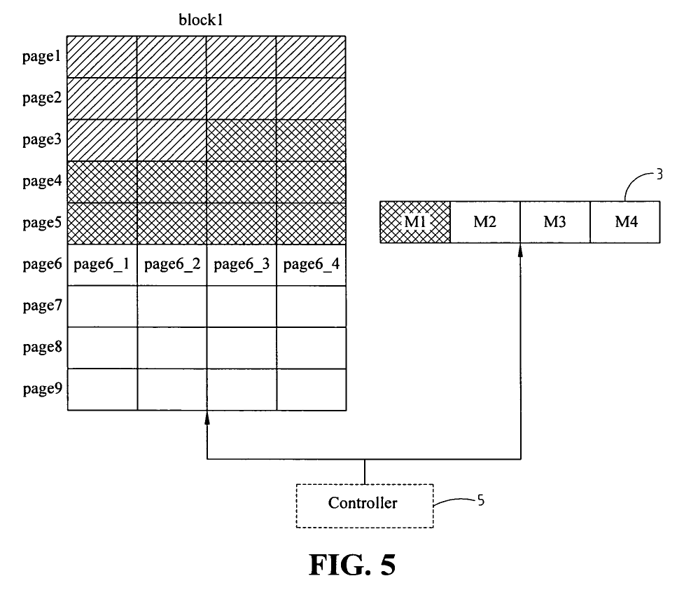

FIG. 5 shows another scenario of the previous example. If the new data has a size greater than 1K (i.e., more than the remaining sectors of page3 can hold), the first 1K new data is still stored in the mirror data area 3 and the full page of data is written back to page3 of block1, as described above. The remaining new data is then written into the subsequent pages (i.e., page4 and page5). If there is some new data that cannot occupy a full page (e.g., that originally to be stored in the sector page6_1), the data is stored in the sector M1 of the mirror data area 3 as described above.

In previous examples, the new data is assumed to have a starting target address following the end of the previously written data. However, this may not always be the case. If the new data subsequently to be written does not follow immediately behind the previously written data, the page in the mirror data area 3 is first written back to their original place (i.e., starting from the sectors page3_1 of block1). The new data is then written into the NAND flash memory 1 following the same process.

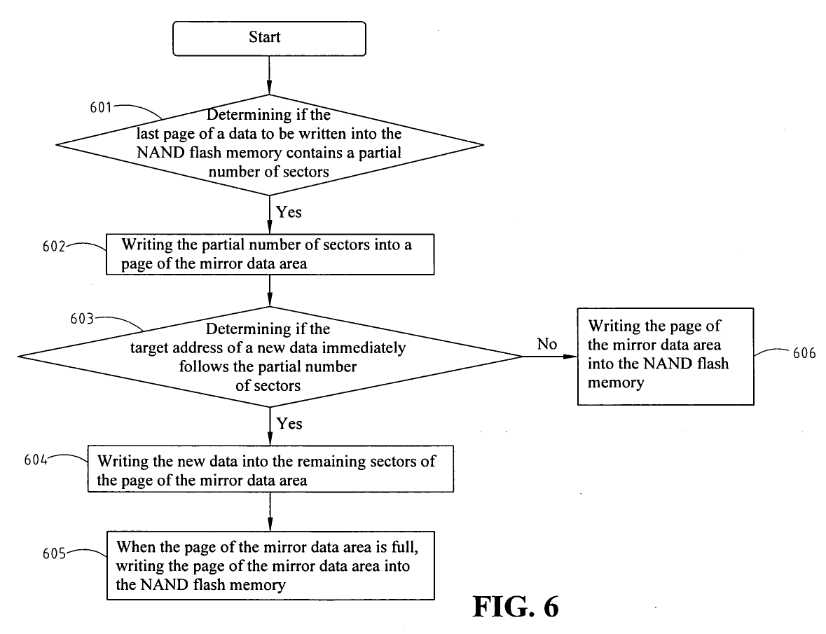

FIG. 6 is a flow chart showing the processing steps of the method provided by the present invention. As illustrated, when a data is to be written into a block of a NAND flash memory, it is determined first that if the last page of the data would be partially filled in step 601. If yes, the sectors of the last page are written instead in a page of the mirror data area while the previous pages are written into the NAND flash memory in step 602. If no, the data is written following ordinary NAND flash memory operation and therefore is not shown in the flow chart. Then, in step 603, when a new data is subsequently to be written into the NAND flash memory, it is determined whether the new data has a starting target address following immediately behind the partial number of sectors. If no, the page containing the partial number of sectors in the mirror data area is written back its original place in the NAND flash memory in step 606. The new data is then written into the NAND flash memory following the same method. If the result of step 603 is “yes,” the new data is first written into the remaining sectors of the page of the mirror data area in step 604. When the mirror data area contains a full page of data, the entire page is written back into the original place in the NAND flash memory in step 605. Not explicitly shown in the flow chart, if there is still some remaining new data, the remaining new data is written into the NAND flash memory following the same method.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A NAND flash memory device, comprising:
a NAND flash memory containing a plurality of blocks, each block containing a plurality of pages, each page containing a plurality of sectors;
a mirror data area formed by random access memory whose size is at least a page; and
a controller controlling the access to said NAND flash memory and said mirror data area;
wherein, when a first data is to be written into said NAND flash memory and the last page of said first data to be written into a first page of said NAND flash memory contains a partial number of sectors, said controller writes the previous pages of said first data into said NAND flash memory and said partial number of sectors into corresponding sectors of a second page of said mirror data area; when subsequently a second data is to be written into said NAND flash memory and said second data has a target address immediately following said partial number of sectors, said controller writes said second data into the remaining sectors of said second page of said mirror data area; when said second page of sad mirror data area is full, said controller first writes entire said second page into said first page of said NAND flash memory; and said controller treats the remaining data of said second data as said first data and repeats the foregoing process.

2. The NAND flash memory device according to claim 1, wherein, when subsequently a third data is to be written into said NAND flash memory and said third data has a target address not immediately following said partial number of sectors, said controller writes entire said second page of said mirror data area back to said first page of said NAND flash memory; and said controller treats said third data as said first data and repeats the foregoing process.

3. A method for controlling access of a NAND flash memory, comprising the steps of:
providing a mirror data area formed by random access memory and has a size of at least a page;
when a first data is to be written into a NAND flash memory, determining if the last page of said first data to be written into a first page of said NAND flash memory contains a partial number of sectors;
if yes, writing the previous pages of said first data into said NAND flash memory and said partial number of sectors into corresponding sectors of a second page of said mirror data area;
when subsequently a second data is to be written into said NAND flash memory; determining if the target address of said second data immediately follows said partial number of sectors;
if yes, writing said second data into the remaining sectors of said second page of said mirror data area;
when said second page of said mirror data area is full, writing said second page of said mirror data area into said first page of said NAND flash memory; and
treating the remaining data of said second data as said first data and repeating said method.

4. The method according to claim 3, further comprising the steps of:
if the target address of said second data does not immediately follows said partial number of sectors, writing entire said second page of said mirror data area back to said first page of said NAND flash memory; and
treating said second data as said first data and repeating said method.
